(19) United States
(12) Patent Application Publication
(10) Pub. No.: US 2009/0210943 A1
(43) Pub. Date: Aug. 20, 2009

(54) Method to detect viruses hidden inside a password-protected archive of compressed files

(76) Inventors: Galit Alon, Haifa (IL); Yanki Margalit, Ramat Gan (IL); Dany Margalit, Ramat Chen (IL)

Correspondence Address: HOFFMAN, WASSON & GITLER, P.C., Suite 522, 2461 South Clark Street, Arlington, VA, 22202, US

(21) Appl. No.: 11/979,085

(22) Filed: Oct. 31, 2007

Related U.S. Application Data
(63) Continuation-in-part of application No. 11/028,594, filed on Jan. 5, 2005, now abandoned.
(60) Provisional application No. 60/607,709, filed on Sep. 8, 2004.

(51) Int. Cl. G06F 21/00; G06F 12/14; G06F 12/00

(52) U.S. Cl. 726/24; 707/200; 707/E17.01; 707/E17.044

(57) ABSTRACT

A method for inspecting a compressed archive file for virus infection without having to decompress the files contained therein. Data in the archive header is used to determine the probability that the compressed archive is infected. Default parameters used for the compression, the compression ratio, the number of files stored in the compressed archive, and the total size of the archive are factors utilized during inspection according to the present invention to detect archives with a high probability of infection, as well as to recognize archives with a low probability of infection. The method is especially beneficial when the archive has been encrypted or password-protected and the files contained therein cannot be decompressed, but is also advantageous when decompression is possible. In addition, use of the present invention avoids the danger of attempting to decompress a malicious archive containing an archive bomb.

The present application is a continuation-in-part of U.S. patent application Ser. No. 11/028,594, filed Jan. 5, 2005, which claimed benefit of U.S. Provisional Patent Application No. 60/607,709:filed Sep. 8, 2004.

### FIELD OF THE INVENTION

The present invention relates to the field of computer virus detection, and, more particularly, to a method for detecting virus-infected files contained within an archive file.

### BACKGROUND OF THE INVENTION

Archive files (including, but not limited to files such as: ZIP, RAR, 7z, GZIP, TAR, BZIP2, CAB, LZH, and so forth) are used to hold one or more files in a convenient manner for storage and transmission. Typically, files stored or contained in an archive (referred herein as “local files”) are stored in a compressed manner to decrease the storage/transmission volume. Furthermore, local files may also be stored in an encrypted and/or password-protected form to prevent unauthorized access. The compression/encryption/password protection preserves the content and capabilities the local files, but renders them into a form which differs from that of the original uncompressed/unencrypted/non-password-protected file. Thus, an infected file that is compressed/encrypted/password-protected and stored in an archive retains the potential to cause damage, but is not readily recognized as being infected by a virus by prior-art inspection facilities. Therefore, before inspecting an archive file using prior-art methods (scanning for viruses, etc.), the local files stored within the archive typically have to be decompressed/decrypted to restore them to their native form.

Unfortunately, it is often difficult or impossible to decompress/decrypt an archive file. For example, when an archive file is encrypted or is protected by a secret password, the virus scanner typically lacks the decryption key/password. The terms “encrypted archive” and “password-protected archive” are herein treated as equivalent within the scope of the present invention, in that the same effect is achieved—the inability of a virus scanner to decompress the local files of a compressed archive into their original uncompressed form for inspection.

Furthermore, even if the archive is not encrypted or protected by a password, decompressing the files in the archive requires additional time and resources, and slows down the inspection process. Moreover, attackers sometimes include a compressed file within an archive that decompresses into an extremely large file (many terabytes), thereby overloading the computer and preventing the virus scanner from operating. Such an “archive bomb” may be hidden within an archive among virus-infected files to disable an inspection facility from detecting the virus infection.

For these reasons, prior-art anti-virus utilities are not effective in handling archives of compressed files. Some prior-art inspection facilities therefore simply block all compressed archives, or pass them through to users without inspection after issuing a warning.

The use of compressed archives is increasing in various areas, such as Internet data communication, especially in email messages. Attackers are taking advantage of the weakness of inspection utilities in handling compressed archives.

There is thus a widely recognized need for, and it would be highly advantageous to have, a method for efficiently inspecting compressed archives for virus infection, which does not rely on decompressing the inspected. files. This goal is met by the present invention.

### SUMMARY OF THE INVENTION

It is an objective of the present invention to provide a solution for detecting viruses within a compressed/encrypted/password-protected archive without decompressing/decrypting the archive, and without access to the decryption key or the password protecting the archive. Other objectives and advantages of the invention will become apparent as the description proceeds.

The present invention is directed to a method for inspecting an archive by retrieving information from a header of the archive and employing the information therein to determine if the contents are infected by a virus.

According to embodiments of the present invention, information in the header of the compressed archive includes, but is not limited to: parameters of the compressed archive; a compression ratio of one or more files of the archive; the average compression ratio of the files of the archive; an expression of the compression ratio of one or more files of the archive; the size of the archive; the types of the files stored within the archive; the sizes of the files stored within the archive; and the number of files stored within the archive.

According to a non-limiting embodiment of the present invention, the inspection and determination of whether the compressed archive contains a virus is carried out by comparing the compression ratio of an executable stored within the archive with a predetermined threshold, and indicating that the executable is infected by a virus if the compression ratio is less than the threshold.

According to another non-limiting embodiment of the invention, the inspection is carried out by comparing the average compression ratio of the executables of the archive with the predetermined threshold, and indicating that the executable is infected by a virus if the compression ratio is less than the threshold.

In a related embodiment of the present invention, the above-mentioned predetermined threshold is 4%.

According to yet another non-limiting embodiment of the invention, the inspection is carried out by: comparing the compression ratio of an executable of the archive with a threshold; indicating that the executable is suspected to be infected by a virus if the compression ratio is between a first predetermined threshold and a second predetermined threshold. In a related embodiment, the first predetermined threshold is 4% and the second predetermined threshold is 10%.

In the above-mentioned embodiments, compression ratio is as defined below in Equation (1).

In yet further non-limiting embodiments of the present invention, the method further includes determining if the executable is infected by a virus by additional testing thereof, such as, for example, testing to determine whether the overall compression ratio of the archive is less than a third predetermined threshold and whether the number of files stored within the archive is less than a fourth predetermined threshold.

According to a related embodiment of the invention, the above-mentioned third predetermined threshold is 50 KB (fifty kilobytes); and the above-mentioned fourth predetermined threshold is 3 files.

Other non-limiting embodiments of the present invention involve comparison of header data against additional predetermined thresholds.

Therefore, according to the present invention there is provided a method for inspecting a compressed archive for virus infection, the compressed archive having a header and being in a format having a set of default compression parameters, and containing at least one file compressed according to a set of actual compression parameters, the method including: (a) obtaining the actual compression parameters from the header; (b) comparing the actual compression parameters with the default compression parameters for the format; (c) indicating that the at least one file has a high probability of being infected by a virus if the actual compression parameters differ from the default compression parameters; and (d) indicating that the at least one file has a low probability of being infected by a virus if the actual compression parameters are the same as the default compression parameters.

Also, according to the present invention there is provided a method for inspecting a compressed archive for virus infection, the compressed archive having a header and containing at least one file having a compression ratio, the method including: (a) obtaining the compression ratio from the header of the compressed archive; (b) indicating that the at least one file has a high probability of being infected by a virus if the compression ratio is below a predetermined lower threshold; (c) indicating that the at least one file has a low probability of being infected by a virus if the compression ratio is above a predetermined upper threshold; and (d) indicating that the at least one file has neither a low probability nor a high probability of being infected by a virus if the compression ratio is neither below the predetermined lower threshold nor above the predetermined upper threshold.

### BRIEF DESCRIPTION OF THE DRAWINGS

The invention is herein described, by way of example only, with reference to the accompanying drawings, wherein:

FIG. 1 illustrates a hexadecimal dump of a typical compressed archive as displayed by a software viewer, according to the prior art.

FIG. 2 illustrates a character-mapped ASCII dump of a typical compressed archive as displayed by a software viewer, according to the prior art.

FIG. 3 is a flowchart illustrating a method for determining whether an archive contains a virus-infected file, according to a preferred embodiment of the present invention.

FIG. 4 is a flowchart of a method for inspecting an archive for virus infection according to an embodiment of the present invention.

FIG. 5 is a flowchart of a method for determining virus infection on a local file of an archive, according to an embodiment of the present invention.

FIG. 6 is a flowchart illustrating method for determining whether an archive contains a virus-infected file, according to an embodiment of the present invention.

### DESCRIPTION OF THE PREFERRED EMBODIMENTS

The principles and operation of a method for detecting viruses in a compressed archive according to the present invention may be understood with reference to the drawings and the accompanying description.

### Compression Ratio

For purposes of the present application, the compression ratio C of a file in a compressed archive is herein defined as:

$$C = ( 1 - \frac{compressedSize}{originalSize} ) , \qquad ( Equation 1 )$$

Where compressedSize is the size of the compressed file (in bytes) within the archive; and originalSize is the size of the file (in bytes) in the original uncompressed (or decompressed) state. Without loss of generality, C as defined according to Equation (1) may be expressed in terms of a percentage.

As a non-limiting illustrative example, let a first file when uncompressed have originalSize=925 Kbytes. When put into a compressed file archive, the first file has compressedSize=341 Kbytes. According to Equation (1), the compression ratio for the first file, C₁=63%. Then, let a second file when uncompressed also have originalSize=925 Kbytes. When put into a compressed file archive, however, the second file has compressedSize=905 Kbytes. According to Equation (1), the compression ratio for the second file, C₂=2%. That is, according to the present definition of compression ratio, as expressed by Equation (1), the more the file is compressed, the higher the value of C. In this non-limiting illustrative example, the first file compresses far more than the second file, and thus has a much higher value of C.

It is expressly understood that Equation (1) is evaluated by comparing the size of the subject file in two distinctly different states, namely that compressedSize refers to the size of the file in the compressed state, whereas originalSize refers to the size of the file in the uncompressed state. Specifically, Equation (1) does not apply in the case where a file has been compressed and afterwards decompressed (so-called “round-tripping”). It is noted that for lossless compression, a file that has been compressed and subsequently decompressed without error will be identical to the original file prior to compression and therefore will have the exact same size—and that computing a ratio between the original uncompressed file size and the final decompressed file size is of no use or interest. It is also noted that when a file has been compressed, further compression is typically not possible, and results in a low compression ratio, as defined by Equation (1), or even a negative compression ratio, where the attempted further compression results in an expansion of the file size.

It is understood that, besides Equation (1), there are other defining equations in the field of the present invention, and that for purposes of the present application numerical values of compression ratios according to other defining equations are to be converted as necessary in order to be defined according to Equation (1).

### Determination of Virus Infection

According to the present invention, it is possible to determine if an archive of one or more compressed files contains a file that is infected by a virus, wherein the determination is probabilistic. Terms such as “probably infected”, “high probability of infection”, and “probably” in regard to virus infection of a particular file herein denote: that there is reason to believe that the file may be infected by a virus; that the file is suspected of being infected by a virus; that there exists a risk in using the file because of possible virus infection; and/or that prudent file security practices recommend that the file be considered infected by a virus until further definitive testing verifies otherwise.

Similarly, terms such as “probably not infected”, “low probability of infection”, and “probably not” in regard to virus infection of a particular file herein denote: that there is reason to believe the file is not infected by a virus; that the file is not suspected of being infected by a virus; and/or that prudent file security practices recommend that the file be considered not infected by a virus unless further definitive testing determines otherwise.

### Compressed Archives

FIG. 1 illustrates a display 101 of a hexadecimal dump of a typical compressed archive file (a ZIP file). The compressed archive includes one or more local files. The general format of a local file in a prior-art compressed archive typically includes, but is not limited to: a local file header; file data; and a data descriptor, as described below for a typical prior-art compressed archive file (a ZIP file).

### Local File Header:

TABLE 1
Prior-Art Local File Header (typical)

| Data | Size |
|---|---|
| local file header signature | 4 bytes (0x04034b50) |
| version needed to extract | 2 bytes |
| general purpose bit flag | 2 bytes |
| compression method | 2 bytes |
| last mod file time | 2 bytes |
| last mod file date | 2 bytes |
| CRC-32 | 4 bytes |
| compressed size | 4 bytes |
| uncompressed size | 4 bytes |
| file name length | 2 bytes |
| extra field length | 2 bytes |
| file name (variable size) | |
| extra field (variable size) | |

### File Data

Immediately following the local header for a file (Table 1, above) is the compressed or stored data for the file. The series <local file header> <file data> <data descriptor> repeats for each file in the archive.

### Data Descriptor

TABLE 2
Prior-Art Data Descriptor (typical)

| Data | Size |
|---|---|
| CRC-32 | 4 bytes |
| compressed size | 4 bytes |
| uncompressed size | 4 bytes |

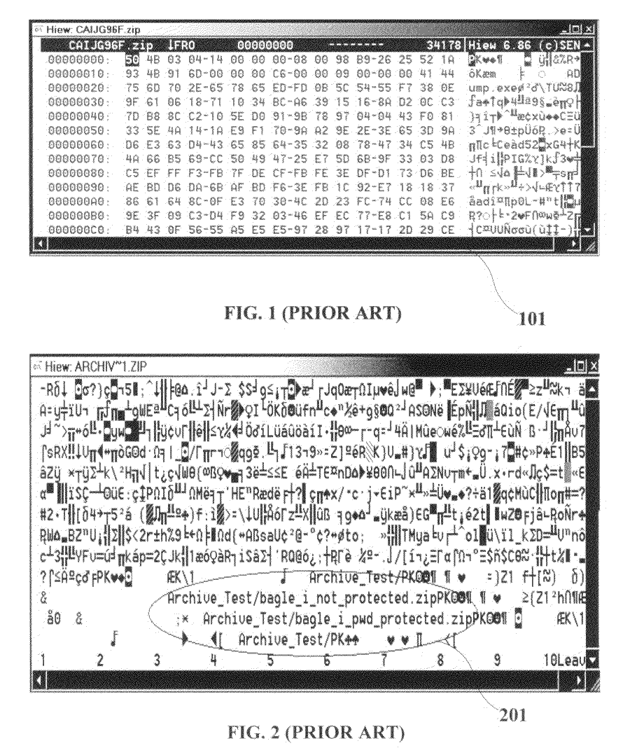

FIG. 2 illustrates an archive file as viewed by a hex viewer, according to the prior art. It is noted that, even when the contents of the archive file is encrypted or protected by a password, a file header 201 (a portion of which is illustrated within an elliptical boundary) is accessible and readable. File header 201 describes the parameters of the compressed file(s) within the archive.

### Principal Anomaly in Virus-Infected Compressed Archives

The present inventors have discovered that virus-infected files are typically packed into compressed archives in a manner that differs from the way files are normally stored in a compressed archive.

In the case of a normal (non-malicious) compressed file stored in an archive by a normal computer user, the user typically employs a computer file compression utility which compresses files according to a specified format (non-limiting examples of which include programs such as: PKZIP, WinZIP, and 7z), designates the name and location of the file to be compressed, and activates the utility to perform the file compression operation. The resulting output from the file compression utility is a compressed archive in the specified format which contains the file designated by the user. Under such circumstances, the resulting compression is typically done according to a set of default parameters associated with the format as assigned by the file compression utility, and these parameters can be obtained from the compressed archive header.

In the case of a malicious compressed file stored in an archive by an attacker, however, the attacker typically utilizes a custom utility whose intended function is creating malicious virus-infected compressed archives. Although such virus utilities utilize the same formats of legitimate file compression utilities (such as PKZIP, for example), the virus utilities typically use non-standard parameters for the compression.

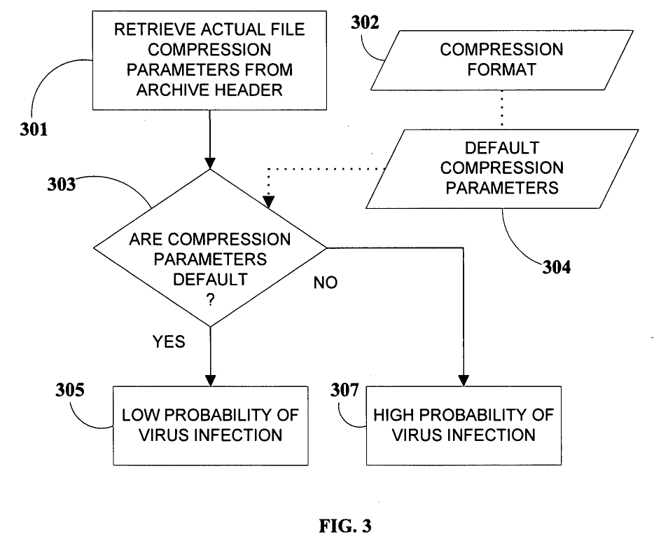

Therefore, according to a preferred embodiment of the present invention, it is possible to determine if a compressed archive contains any virus-infected files by inspecting the archive header. Reference is now made to FIG. 3, which is a flowchart of a method for inspecting an archive, according to this preferred embodiment of the invention.

In a step 301, the actual compression parameters used to compress the file are retrieved from the header of the compressed archive, which has a compression format 302. Next, at a decision point 303, these actual parameters are checked to see if they are the same as default parameters 304 assigned by a regular file compression utility available to normal users (see above). If the actual compression parameters are the same as default parameters 304, then in a step 305, the archive is determined to have a low probability of virus infection. If, however, the actual compression parameters differ from default compression parameters 304, then in a step 307, the archive is determined to have a high probability of virus infection.

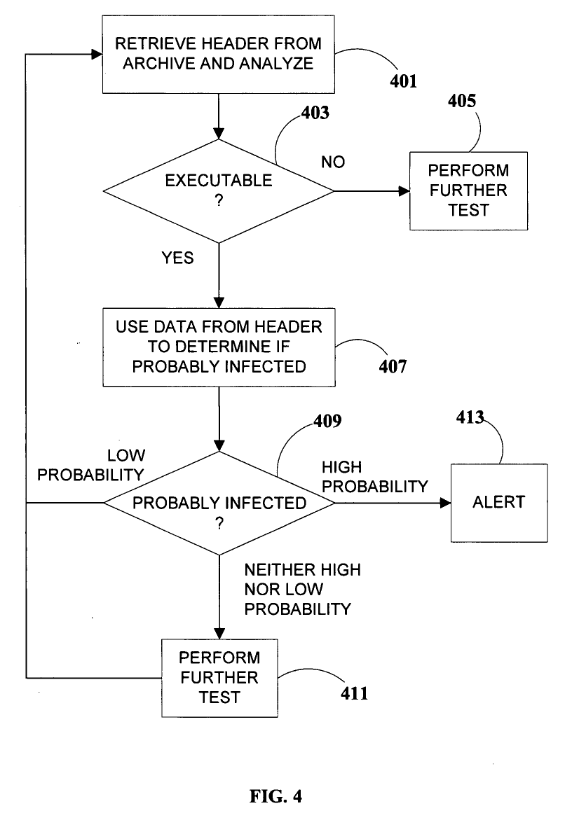

Reference is now made to FIG. 4, which is a flowchart of a method for inspecting an archive, according to another embodiment of the present invention.

Assuming all the files of an archive are processed, at a block 401 the header of the next local file is retrieved, and at a decision point 403 the type of the local file is analyzed. The type can be indicated, for example, by the extension of a file, by its first bytes, etc. For example, “exe” and “COM” are extensions of executables in typical operating system environments. Then, if the file is an executable, the flow continues to a step 407, where one or more tests are carried out, based on the data retrieved from the header, as detailed below. Otherwise, if the file is not an executable, flow continues to a step 405, for further integrity tests, such as those which are already well-known in the prior-art.

After the header data is retrieved in step 407, a decision-point 409 determines virus infection according to testing by other embodiments of the present invention (such as previously discussed and illustrated in FIG. 3). If it is determined that there is a high probability that the file is infected by a virus, an alert is signaled in a step 413, such as, for example, warning the user and deleting the infected file from the archive. If it is determined that there is a low probability that the file is infected by a virus, the next file header is retrieved and analyzed in step 401. If there is neither a high nor a low probability that the file is infected by a virus, in a step 411, additional tests are performed (similar to those of step 405) before retrieving and analyzing the next file header in step 401.

### Additional Anomalies in Virus-Infected Compressed Archives

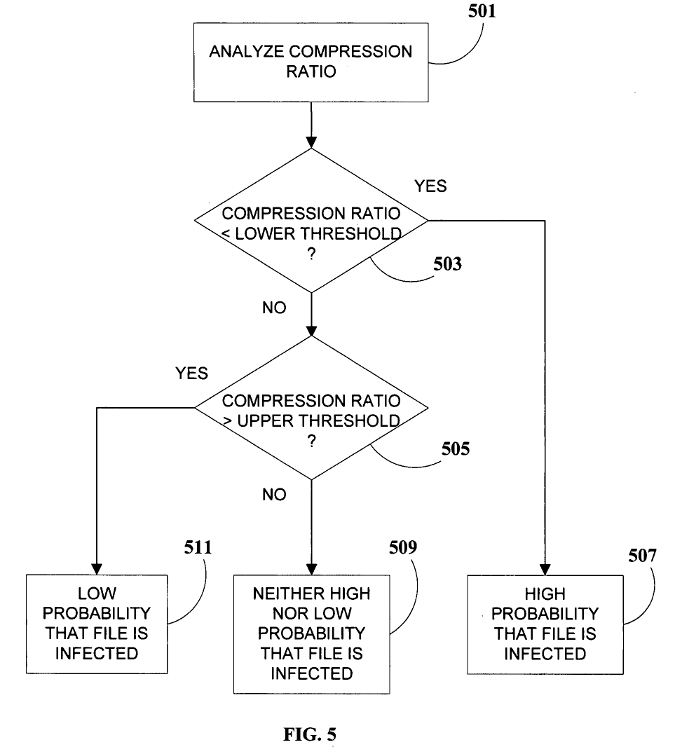

In addition to the above criteria involving compressed file header data, as previously discussed and illustrated in FIG. 3, the present inventors have discovered that the compression ratio of executables infected by a virus typically lies below a particular lower threshold (for example, below 4%), whereas the compression ratio of non-infected executables typically lies above a particular upper threshold (for example, above 10%). FIG. 5 thus illustrates probabilistic determination of file infection according to an embodiment of the present invention. Starting with a step 501, the compression ratio of an executable file in a compressed archive is analyzed, by reading the archive header data. Once again, the compression ratio is defined by Equation (1), as previously noted. At a decision point 503, if the compression ratio is less than a predetermined lower threshold, in a step 507 the file is considered to be infected with a high probability. If decision point 503 determines that the compression ratio is not less than the predetermined lower threshold, at a decision point 505, if the compression ratio is greater than a predetermined upper threshold, in a step 511, the file is considered to have a low probability of infection. Otherwise, in a step 509, the file is considered to have neither a high nor a low probability of virus infection.

Through research carried out by the present inventors, it has been discovered that a nominal lower threshold for the above test is 4%, and a nominal upper threshold for the above test is 10%, and according to an embodiment of the present invention, these thresholds are used, as described above and as illustrated in FIG. 5. According to another embodiment of the present invention, these thresholds can be varied in conformity with and on-going empirical evaluation of the inspection results, to optimize the accuracy and efficiency of the inspection process.

In addition to the above criteria, the present inventors have further discovered that the number of files in a compressed archive infected by a virus typically lies at or below a particular lower threshold (for example, two files or less).

Through further research carried out by the present inventors, it has also been discovered that a nominal at-or-below threshold for the above test is 2 files (i.e., typical virus-infected compressed archives contain 2 or less files). According to another embodiment of the present invention, this threshold can be varied in conformity with and on-going empirical evaluation of the inspection results, to optimize the accuracy and efficiency of the inspection process.

Moreover, in addition to the above criteria, the present inventors have further discovered that the total size of a compressed archive infected by a virus typically lies below a particular lower threshold (for example, below 50 KB).

Through yet further research carried out by the present inventors, it has also been discovered that a nominal lower threshold for the above test is 50 KB (i.e., typical virus-infected compressed archives have a size less than 50 KB). According to another embodiment of the present invention, this threshold can be varied in conformity with and on-going empirical evaluation of the inspection results, to optimize the accuracy and efficiency of the inspection process.

The term “KB” herein denotes “kilobyte”, where 1 kilobyte is defined in binary terms as 1024 bytes.

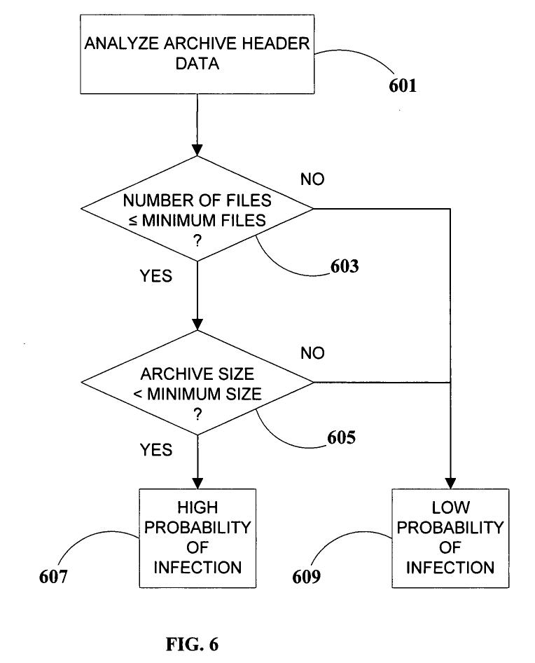

FIG. 6 thus illustrates probabilistic determination of file infection according to an embodiment of the present invention. In a step 601, the compressed archive header data is analyzed. At a decision point 603, if the number of files in the compressed archive is less than or equal to a predetermined minimum file threshold, the archive size is checked at a decision point 605, and if the archive size is below a predetermined minimum size threshold, then in a step 607, the archive is deemed to have a high probability of virus infection. Otherwise, if either decision point 603 or decision point 605 determines that the relevant threshold level is not met, then in a step 609 the archive is deemed to have a low probability of virus infection.

Thus, in addition to testing each executable file separately, the archive can be tested as a whole, e.g. determining the probability of infection by the average compression ratio of the archive's files or executables. According to yet another embodiment of the invention, a combination of examination of each local file along with examination of the entire archive may be used for inspecting the archive. For example, if the compression ratio of an executable is 7%, and its size is greater than 50 KB, then the archive file can be determined to have a low probability of virus infection. However, if the compression ratio of an executable is 7%, and the size thereof is less than 50 KB, then the file can be determined to have a high probability of virus infection.

Accordingly, it is a particularly useful benefit of these embodiments of the present invention that, because the above parameters of a compressed archive and the files therein can be directly determined from the archive header information, a determination of whether the compressed archive and the files therein are infected by a virus can be carried out by employing the header content, without decompressing any local files (i.e., without extracting any files from the archive to original uncompressed form). This is of great benefit in cases where the local files contained by the compressed archive are encrypted or password-protected and cannot be decompressed, and is also beneficial even in cases where the local files are not encrypted or password-protected. This is because the present invention allows inspecting an archive without unpacking its files, thereby enabling inspection of an archive with less processing effort and time than was previously possible. Use of the present invention also avoids the danger inherent in trying to decompress a malicious archive file containing an archive bomb.

Those skilled in the art will also appreciate that the present invention can be implemented on a junction of Internet traffic (such as a gateway to a network, a mail server, etc.) as well as on a personal computer by an anti-virus software, etc.

While the invention has been described with respect to a limited number of embodiments, it will be appreciated that many variations, modifications and other applications of the invention may be made.

1. A method for inspecting a compressed archive for virus infection, the compressed archive having a header and being in a format having a set of default compression parameters, and containing at least one file compressed according to a set of actual compression parameters, the method comprising:
obtaining the actual compression parameters from the header;
comparing the actual compression parameters with the default compression parameters for the format;
indicating that the at least one file has a high probability of being infected by a virus if the actual compression parameters differ from the default compression parameters; and
indicating that the at least one file has a low probability of being infected by a virus if the actual compression parameters are the same as the default compression parameters.

2. A method according to claim 1, wherein the at least one file is an executable.

3. A method according to claim 2, further comprising indicating if said executable is infected by a virus based on at least one additional test.

4. A method according to claim 3, wherein the at least one file has a compression ratio, and said at least one additional test includes determining if said compression ratio is less than a predetermined threshold.

5. A method according to claim 4, wherein said predetermined lower threshold is 4 percent.

6. A method according to claim 3, wherein said at least one additional test includes determining if the number of files stored in the compressed archive is at or below a predetermined file number threshold.

7. A method according to claim 6, wherein said predetermined file number threshold is 2 files.

8. A method according to claim 3, wherein said at least one additional test includes determining if the size of the compressed archive is less than a predetermined threshold.

9. A method according to claim 8, wherein said predetermined threshold is 50 kilobytes.

10. A method for inspecting a compressed archive for virus infection, the compressed archive having a header and containing at least one file having a compression ratio, the method comprising:
obtaining the compression ratio from the header of the compressed archive;
indicating that the at least one file has a high probability of being infected by a virus if the compression ratio is below a predetermined lower threshold;
indicating that the at least one file has a low probability of being infected by a virus if the compression ratio is above a predetermined upper threshold; and
indicating that the at least one file has neither a low probability nor a high probability of being infected by a virus if the compression ratio is neither below said predetermined lower threshold nor above said predetermined upper threshold.

11. A method according to claim 10, wherein the at least one file is an executable.

12. A method according to claim 10, wherein said predetermined lower threshold is 4 percent.

13. A method according to claim 10, wherein said predetermined upper threshold is 10 percent.

14. A method according to claim 11, further comprising indicating if said executable is infected by a virus based on at least one additional test.

15. A method according to claim 14, wherein said at least one additional test includes determining if an overall compression ratio of said archive is less than a predetermined threshold.

16. A method according to claim 14, wherein said at least one additional test includes determining if the number of files stored in the compressed archive is at or below a predetermined file number threshold.

17. A method according to claim 16, wherein said predetermined file number threshold is 2 files.

18. A method according to claim 14, wherein said at least one additional test includes determining if the size of the compressed archive is less than a predetermined threshold.

19. A method according to claim 18, wherein said predetermined threshold is 50 kilobytes.
